(19) United States
(12) Patent Application Publication
(10) Pub. No.: US 2021/0406928 A1
(43) Pub. Date: Dec. 30, 2021

(54) INFORMATION PROCESSING DEVICE, INFORMATION PROCESSING METHOD, AND RECORDING MEDIUM

(71) Applicant: Creator's NEXT Inc., Tokyo (JP)

(72) Inventor: Nozomu KUBOTA, Tokyo (JP)

(73) Assignee: Creator's NEXT Inc., Tokyo (JP)

(21) Appl. No.: 17/466,223

(22) Filed: Sep. 3, 2021

Related U.S. Application Data
(63) Continuation of application No. PCT/JP2020/001924, filed on Jan. 21, 2020.

(30) Foreign Application Priority Data
Mar. 6, 2019 (JP) 2019-040979

(51) Int. Cl. G06Q 30/02; G09B 19/00

(52) U.S. Cl. CPC G06Q 30/0201; G09B 19/00

(57) ABSTRACT

An information processing device includes: an index calculation unit configured to calculate an at least one index of one of actions and reactions by a target on the basis of target information acquired by an information acquisition unit; and a determination unit configured to determine a current psychological status of a plurality of psychological statuses of the target on the basis of the calculated at least one index. After the information acquisition unit acquires the target information, the index calculation unit updates the at least one index on the basis of the acquired target information. After the index calculation unit updates the at least one index, the determination unit determines, on the basis of the updated at least one index, that another one psychological status in a rank that is one of higher and lower than a rank of the current psychological status is a new current-psychological status.

### TECHNICAL FIELD

The technology disclosed herein relates to an information processing device, an information processing method, and a recording medium.

### BACKGROUND

In marketing activities, it is important to predict psychologies of customers and to take appropriate measures. Japanese Patent Application Laid-open No. 2014-98623 discloses a technique for estimating moods of a user on a moment-to-moment basis and on the basis of a history of actions by the user.

### SUMMARY

However, the technology disclosed in Patent Literature 1 is designed to estimate moment-to-moment variation of fragmentary moods (level of a metal load). This technology is disadvantageous in that stepwise development of psychological statuses of the customers in accordance, for example, with the marketing activities cannot be clearly grasped.

In view of such circumstances, the technology disclosed herein has been made to provide an information processing device, an information processing method, and a program that enable shifts between psychological statuses of a target to be clearly grasped on the basis of information acquired from the target.

### Solution to Problem

According to an embodiment of the technology disclosed herein, there is provided an information processing device including:

an at least one processor; and

a storage unit configured to store an at least one program that can be executed by the at least one processor,

in which, when the at least one processor executes the at least one program, the at least one processor implements an information processing method including:
acquiring target information about a target;
calculating an at least one index of one of actions and reactions by the target on the basis of the target information after the acquisition;
determining a current psychological status of the target on the basis of the at least one index after the calculation; and
storing the current psychological status after the determination into the storage unit,

in which the current psychological status is one of a plurality of psychological statuses that shift in a stepwise manner,

in which a plurality of requirements corresponding to the plurality of psychological statuses are defined,

in which the plurality of requirements are each a requirement to be satisfied by the at least one index,

in which the calculating of the at least one index includes updating the at least one index on the basis of the target information after the acquisition, and

in which the determining of the current psychological status includes determining that, of the plurality of psychological statuses, another one psychological status in a rank higher than a rank of the current psychological status to be stored in the storage unit is a new current-psychological status if the at least one index after the update has satisfied one requirement of the plurality of requirements, the one requirement corresponding to the other one psychological status in the higher rank.

According to another embodiment of the technology disclosed herein, there is provided an information processing method to be executed by an at least one computer, the information processing method including:

acquiring target information about a target;

calculating an at least one index of one of actions and reactions by the target on the basis of the target information after the acquisition;

determining a current psychological status of the target on the basis of the at least one index after the calculation; and

storing the current psychological status after the determination into a storage unit,

in which the current psychological status is one of a plurality of psychological statuses that shift in a stepwise manner,

in which a plurality of requirements corresponding to the plurality of psychological statuses are defined,

in which the plurality of requirements are each a requirement to be satisfied by the at least one index,

in which the calculating of the at least one index includes updating the at least one index on the basis of the target information after the acquisition, and

in which the determining of the current psychological status includes determining that, of the plurality of psychological statuses, another one psychological status in a rank higher than a rank of the current psychological status to be stored in the storage unit is a new current-psychological status if the at least one index after the update has satisfied one requirement of the plurality of requirements, the one requirement corresponding to the other one psychological status in the higher rank.

According to a still another embodiment of the technology disclosed herein, there is provided a non-transitory tangible recording medium that stores an at least one program for causing an at least one computer to implement an information processing method, the information processing method including:

acquiring target information about a target;

calculating an at least one index of one of actions and reactions by the target on the basis of the target information after the acquisition;

determining a current psychological status of the target on the basis of the at least one index after the calculation; and

storing the current psychological status after the determination into a storage unit,

in which the current psychological status is one of a plurality of psychological statuses that shift in a stepwise manner,

in which a plurality of requirements corresponding to the plurality of psychological statuses are defined,

in which the plurality of requirements are each a requirement to be satisfied by the at least one index,

in which the calculating of the at least one index includes updating the at least one index on the basis of the target information after the acquisition, and

in which the determining of the current psychological status includes determining that, of the plurality of psychological statuses, another one psychological status in a rank higher than a rank of the current psychological status to be stored in the storage unit is a new current-psychological status if the at least one index after the update has satisfied one requirement of the plurality of requirements, the one requirement corresponding to the other one psychological status in the higher rank.

### Advantageous Effects of Invention

According to the embodiments of the technology disclosed herein, the shifts between the psychological statuses of the target can be clearly grasped on the basis of the information acquired from the target.

### BRIEF DESCRIPTION OF DRAWINGS

FIG. 1 is a diagram showing an example of a configuration of a system including an information processing device according to a first embodiment of the present invention.

FIG. 2 is a diagram showing an example of a configuration of the information processing device according to the first embodiment.

FIG. 3 is a chart showing an example of psychological statuses to be determined by a determination unit.

FIG. 4 is a table showing an example of indices to be used for calculation of evaluation values.

FIG. 5A is a chart showing an example of a configuration of a record to be recorded in a database.

FIG. 5B is an explanatory chart showing terms of psychological statuses to be recorded in the database.

FIG. 6 is an explanatory flowchart of a procedure for determining the psychological statuses of a target on the basis of target information in the information processing device according to the first embodiment.

FIG. 7 is an explanatory flowchart showing an example of a procedure in the determination unit of the information processing device according to the first embodiment.

FIG. 8 is an explanatory flowchart showing a first modification of the procedure in the determination unit of the information processing device according to the first embodiment.

FIG. 9 is an explanatory flowchart showing a second modification of the procedure in the determination unit of the information processing device according to the first embodiment.

FIG. 10 is another explanatory flowchart showing the second modification of the procedure in the determination unit of the information processing device according to the first embodiment.

FIG. 11 is an explanatory flowchart showing a third modification of the procedure in the determination unit of the information processing device according to the first embodiment.

FIG. 12 is an explanatory flowchart showing an example of a procedure in the determination unit of the information processing device according to a second embodiment of the present invention.

FIG. 13 is an explanatory flowchart showing a first modification of the procedure in the determination unit of the information processing device according to the second embodiment.

FIG. 14 is another explanatory flowchart showing the first modification of the procedure in the determination unit of the information processing device according to the second embodiment.

FIG. 15 is an explanatory flowchart showing a second modification of the procedure in the determination unit of the information processing device according to the second embodiment.

### DETAILED DESCRIPTION OF THE EMBODIMENTS

### First Embodiment

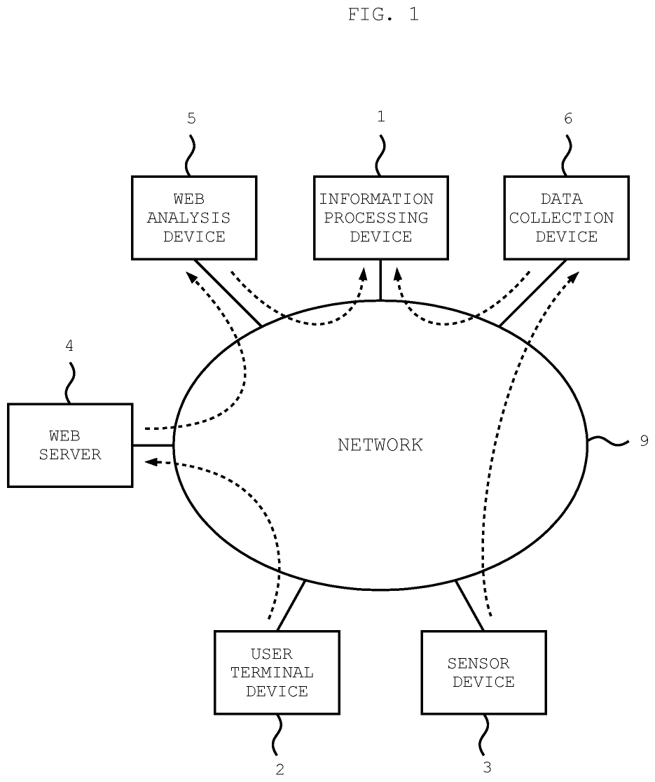

FIG. 1 is a diagram showing an example of a configuration of a system including an information processing device 1 according to a first embodiment of the present invention. The information processing device 1 according to the first embodiment is a device that determines psychological statuses of a target on the basis of information acquired from the target. This information processing device 1 is connected to a network 9 such as the Internet.

A user terminal device 2 is a device to be operated by the target, such as a personal computer or a smartphone. This user terminal device 2 makes access to a WEB server 4 via the network 9. The user terminal device 2 is operated, for example, to view WEB pages, download content, purchase items, and post comments on the WEB server 4.

A WEB analysis device 5 collects and analyses respective histories of access to the WEB server 4 by targets. The WEB analysis device 5 analyses, for example, paths to WEB sites, dates and times of visits to the WEB sites, the number of the visits, the number of pages viewed on the WEB sites, the number of respective clicks on buttons on the WEB pages. The information processing device 1 acquires, as target information, information about the WEB access by each of the targets, the information being analyzed by the WEB analysis device 5.

A sensor device 3 is a device that directly or indirectly detects physical actions or reactions by the target including one or more targets. Specifically, a microphone that detects sound, a biosensor that detects biological activities (such as brain activity, eye movements, heartbeats, breathing, and body temperature), an acceleration sensor that detects body movements, a camera that captures facial expressions and gestures, a sensor that detects a geographic position in response to a GPS signal or the like, a touch sensor that detects touch operations by the target, or the like is used as the sensor device 3.

The sensor device 3 may detect individual targets, or may be a crowd including the targets. The microphone to be used as the sensor device 3 may detect, for example, volume of voice of the crowd, for example, in a venue of an event in which a large number of people participate. In this case, the volume of the voice, which is detected by the microphone, is information that indicates a level of excitement of the event. When the target participates in this event, the information about the level of the excitement of the event, which is analyzed on the basis of results of the detection by the microphone, is the target information about feelings that the target have had by participating in the event.

In addition, the sensor device 3 may be brain-activity measuring devices (such as NIRS devices) that are mounted to the heads of some of participants at the event venue or the like and that detect their brain activities. Also in this case, as in the case of the microphone, patterns of the brain activities measured by the brain-activity measuring devices are the information that indicates the level of the excitement of the event. Thus, the information, which is analyzed on the basis of results of the detection by the brain-activity measuring devices and which indicates the level of the excitement of the event, is the target information about the feelings that the target have had by participating in the event.

A data collection device 6 collects data of the one or more targets detected by the sensor device 3. In the example shown in FIG. 1, the data collection device 6 receives the data that is transmitted from the sensor device 3 via the network 9. The information processing device 1 acquires, as the target information, the data that is detected by the sensor device 3 and is collected by the data collection device 6.

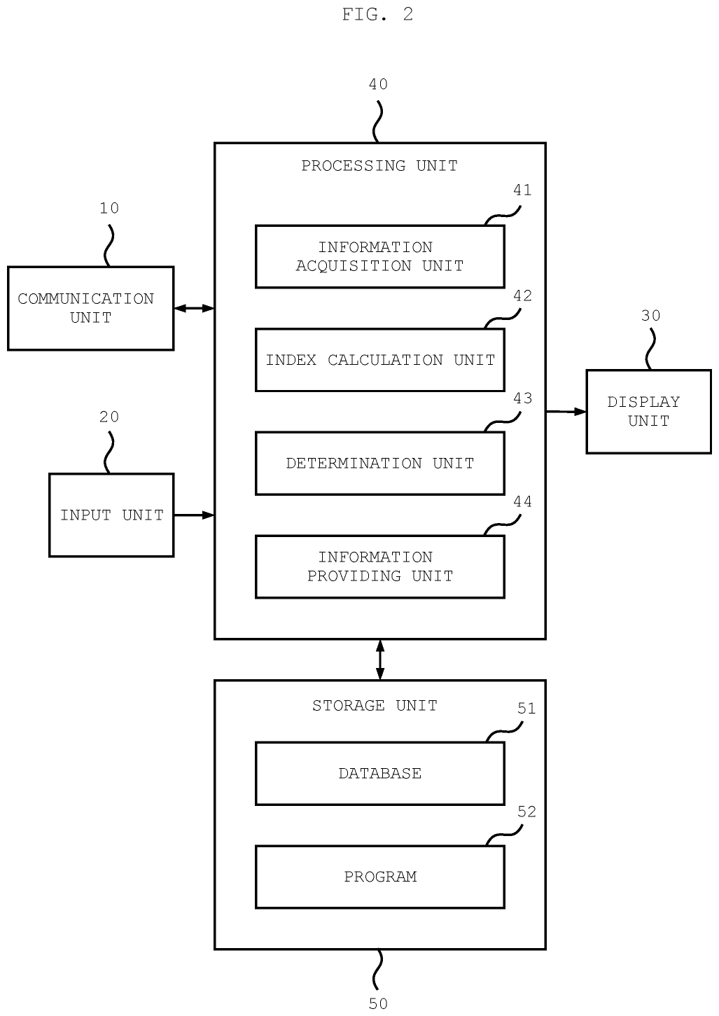

FIG. 2 is a diagram showing an example of a configuration of the information processing device 1 according to the first embodiment. The information processing device 1 shown in FIG. 1 includes a communication unit 10, an input unit 20, a display unit 30, a processing unit 40, and a storage unit 50.

The communication unit 10 is a device for communicating with the WEB analysis device 5 and the data collection device 6 via the network 9. This communication unit 10 includes a communication circuit that performs the communication according to a predetermined communication protocol.

The input unit 20 is a device for allowing operation commands by the user of the information processing device 1 or data to be input. Examples of this input unit 20 includes a user interface device such as a keyboard, a mouse, a touchpad, or a touchscreen, and includes a device that reads recording media (such as an optical disk, an IC tag, a memory card, and a USB flash drive).

The display unit 30 is a device for displaying information such as images and letters to the user of the information processing device 1. Examples of this display unit 30 include a display device such as a liquid crystal display or an OLED display.

The processing unit 40 is a device that controls overall processes in the information processing device 1. This processing unit 40 includes one or more processors that execute processes in accordance with instructions of one or more programs 52 that are stored in the storage unit 50. The processing unit 40 causes the one or more processors to execute the one or more programs 52 stored in the storage unit 50. In this way, the processing unit 40 runs as one or more computers.

Note that, the processing unit 40 may include one or more dedicated hardware modules configured to implement specific functions (for example, integrated circuits such as FPGAs and ASICs). In this case, the processing unit 40 may cause the one or more computers to execute all the information processes in the information processing device 1, or may cause the dedicated hardware modules to execute at least some of the information processes.

The storage unit 50 stores the one or more programs 52 to be loaded to and executed by the one or more computers as the processing unit 40, data that is temporarily stored in the processes to be executed by the processing unit 40, and a database 51 that is managed by the processing unit 40. The storage unit 50 includes one or more storage devices of one or more types, such as a hard disk drive, a flash memory, an optical recording medium, a DRAM, and an SRAM.

The one or more programs 52 may be recorded in non-transitory tangible recording media such as the memory card and the USB flash drive. In this case, the processing unit 40 may load the one or more programs 52 out of the recording media via the reading device of the input unit 20, and then store the one or more programs 52 into the storage unit 50. Alternatively, the processing unit 40 may download the one or more programs 52, for example, from the server on the network 9 via the communication unit 10, and then store the one or more programs 52 into the storage unit 50.

In the example shown in FIG. 2, the processing unit 40 includes an information acquisition unit 41, an index calculation unit 42, a determination unit 43, and an information providing unit 44. Specifically, the processing unit 40 runs as these processing blocks (the information acquisition unit 41, the index calculation unit 42, the determination unit 43, and the information providing unit 44) by causing the one or more processors to execute the one or more programs 52. Note that, at least some of the processes to be executed by these processing blocks may be executed by the dedicated hardware modules.

The information acquisition unit 41 acquires, as the target information about the targets, the information about the WEB access by each of the targets, the information being analyzed by the WEB analysis device 5, or the data that is detected by the sensor device 3 and is collected by the data collection device 6.

Note that, the target information to be acquired by the information acquisition unit 41 is not limited to the information about the WEB access, or the data that is detected by the sensor device 3. For example, by making access to an arbitrary server on the network 9 such as the Internet, the information acquisition unit 41 may acquire various other information about targets than the information about the WEB access and the data that is detected by the sensor device 3. Alternatively, the information acquisition unit 41 may acquire, as the target information, not only the information to be acquired from the server on the network 9, but also, for example, information to be input via the input unit 20 of the information processing device 1.

The index calculation unit 42 calculates one or more indices of the actions or the reactions by each of the individual targets on the basis of the target information acquired by the information acquisition unit 41, and records the calculated indices of each of the targets into the database 51. (Below, an arbitrary index to be calculated by the index calculation unit 42 may be referred to as an “index IN.”) For example, the index calculation unit 42 calculates, on the basis of the target information acquired from the WEB analysis device 5, the number of the visits to the WEB sites, the number of the pages viewed on the WEB sites, the times when the WEB sites are used, the number of the respective clicks on the buttons on the WEB pages, and the like respectively as the indices IN, and records these indices IN into the database 51.

In addition, the index calculation unit 42 calculates, on the basis of the data that is detected by the sensor device 3 and is acquired from the data collection device 6, indices IN of actions or reactions by the targets in the real world, which cannot be acquired on the network 9. For example, when the data that is detected by the sensor device 3 is the above-described data that is obtained in the venue of the event (such as audio data from the microphone, or measurement data from the brain-activity measuring devices), the index calculation unit 42 calculates, on the basis of the obtained data, a value that indicates the level of the excitement of the event as the index IN. The index calculation unit 42 specifies, of the targets, ones who participated in the event on the basis of the target information such as ticket purchase histories on the WEB sites, and records numerical values of the level of the excitement of the event as indices IN of the specified ones of the targets into the database 51.

After the information acquisition unit 41 acquires additional target information about one of the targets, the index calculation unit 42 updates the one or more indices IN of the action or the reaction by the one of the targets on the basis of the acquired target information, and records the updated one or more indices IN into the database 51.

The determination unit 43 determines respective current-psychological statuses CS of the targets on the basis of the indices IN calculated by the index calculation unit 42, and records these current psychological statuses CS into the database 51.

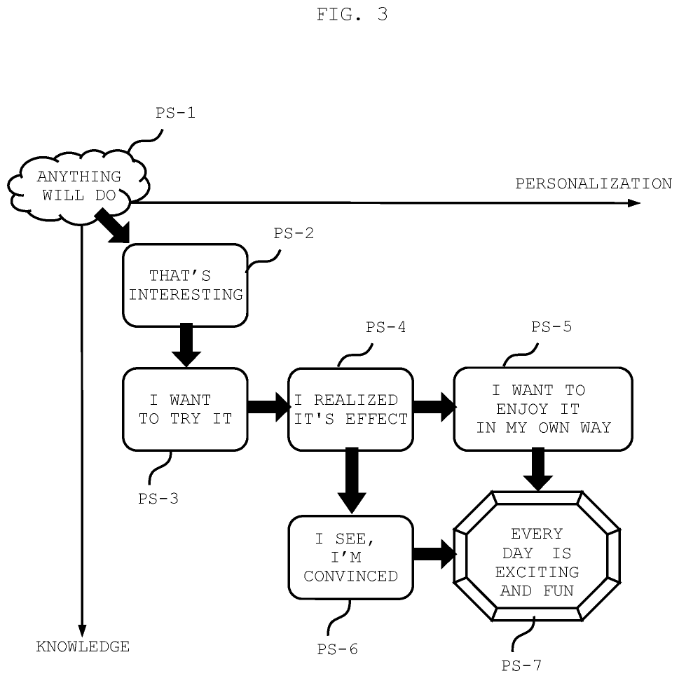

FIG. 3 is a chart showing an example of the psychological statuses to be determined by the determination unit 43. The current psychological status CS to be determined by the determination unit 43 is one of a plurality of psychological statuses that shift in a stepwise manner. In the example shown in FIG. 3, the plurality of these psychological statuses are denoted by reference symbols “PS-1,” “PS-2,” “PS-3,” “PS-4,” “PS-5,” “PS-6,” and “PS-7.” (Below, an arbitrary one of the plurality of psychological statuses may be referred to as a “psychological status PS.”) Specifically, all the psychological statuses PS represent feelings or psychological orientations that the targets (customers) have in relationships with products or services to be provided by businesses and the like. In the example shown in FIG. 3, the psychological statuses PS are represented by phrases such as “Anything will do,” “That's interesting,” “I want to try it,” “I realized it's effect,” “I want to enjoy it in my own way,” “I see, I'm convinced,” and “Every day is exciting and fun.” The plurality of psychological statuses PS that are assumed in the first embodiment are statuses that develop in a stepwise manner as the connection between the products and the services and the targets (customers) becomes deeper. In the example shown in FIG. 3, the psychological status PS-1 is in a lowest rank, the psychological status PS-7 is in a highest rank, and the psychological statuses PS-2 to PS-6 are plotted therebetween. Note that, the psychological statuses PS-5 and PS-6, which are plotted between the psychological status PS-4 and the psychological status PS-7, are in the same rank as each other.

The plurality of stepwise psychological statuses PS that are assumed in the first embodiment can be analyzed on the basis of a plurality of psychological factors that influence transformations of the psychological statuses PS (psychological transformations). In the example shown in FIG. 3, the abscissa axis represents a psychological factor of “personalization,” and the ordinate axis represents a psychological factor of “knowledge.” In the psychological status PS-1 “Anything will do” in the lowest rank, both a level of the “personalization” and a level the “knowledge” are minimum. In the psychological status PS-7 “Every day is exciting and fun” in the highest rank, both the level of the “personalization” and the level the “knowledge” are maximum. The example shown in FIG. 3 demonstrates that, of the indices IN, ones relating to the “personalization” influence the psychological transformation in the horizontal direction in FIG. 3, and that, of the indices IN, ones relating to the “knowledge” influence the psychological transformation in the vertical direction in FIG. 3.

In the first embodiment, a plurality of requirements corresponding to the plurality of psychological statuses PS are defined. (Below, an arbitrary one of the plurality of requirements may be referred to as a “requirement R.”) In the example shown in FIG. 3, independent requirements R are defined respectively for the psychological statuses PS-1 to PS-7. These requirements R are each a requirement R to be satisfied by the one or more indices IN to be calculated by the index calculation unit 42. If the one or more indices IN updated by the index calculation unit 42 have satisfied the requirement R corresponding to the psychological status PS that is in a rank higher than that of the current psychological status CS, the determination unit 43 determines that this psychological status PS in the higher rank is a new current-psychological status CS.

For example, a plurality of evaluation values corresponding respectively to the plurality of psychological statuses PS are set. (Below, an arbitrary one of the plurality of evaluation values may be referred to as an “evaluation value E.”) In the example shown in FIG. 3, independent evaluation values E are set respectively for the psychological statuses PS-1 to PS-7. These evaluation values E are each a value of a function that uses the one or more indices IN to be calculated by the index calculation unit 42 as variables.

Now, it is assumed that an n-th psychological status PS from the lowest rank is represented as a “psychological status PS(n),” the requirement R that corresponds to the psychological status PS(n) is represented as a “requirement R(n),” and the evaluation value E that corresponds to the psychological status PS(n) is represented as an “evaluation value E(n).” When the determination unit 43 determines whether or not the one or more indices IN calculated by the index calculation unit 42 have satisfied the requirement R(n) corresponding to the psychological status PS(n), the determination unit 43 may calculate the evaluation value E(n) corresponding to the psychological status PS(n) on the basis of the one or more indices IN, and determine whether or not the calculated evaluation value E(n) has satisfied the requirement R(n). Note that, the requirement R(n) is a requirement that is defined for the evaluation value E(n) corresponding to the psychological status PS(n).

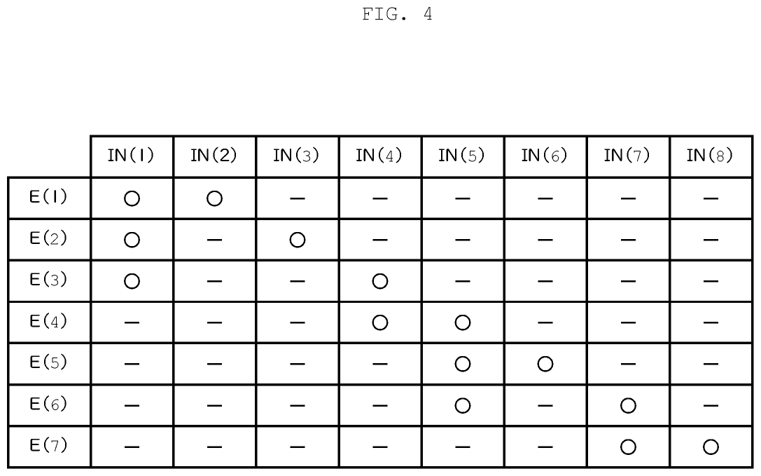

FIG. 4 is a table showing an example of the indices IN to be used for the calculation of the evaluation values E. Seven evaluation values E(1), E(2), E(3), E(4), E(5), E(6), and E(7) in in the example shown in FIG. 4 are respectively values of seven functions that use some of eight indices IN(1), IN(2), IN(3), IN(4), IN(5), IN(6), IN(7), and IN(8) as variables. For example, the evaluation value E(1) is a value of a function that uses the indices IN(1) and IN(2) as the variables, and the evaluation value E(2) is a value of a function that uses the indices IN(1) and IN(3) as the variables.

The functions to be used for calculating the evaluation values E in the determination unit 43 may be arbitrarily set in accordance with the assumed psychological statuses PS. For example, the determination unit 43 may calculate the evaluation values E by adding up products that are obtained by multiplying the indices IN to be used as the variables by respective weighting coefficients. Alternatively, the determination unit 43 may calculate the evaluation values E by setting thresholds respectively for the plurality of indices IN to be used as the variables, and by counting, of the plurality of indices IN, ones that have exceeded the thresholds of these indices IN.

When the determination unit 43 determines whether or not the calculated evaluation value E(n) of the psychological status PS(n) has satisfied the requirement R(n), the determination unit 43 may make the determination on the basis of results of comparison between a threshold that is set for the requirement R(n) (below, sometimes referred to as a “threshold TH(n)”) and the evaluation value E(n). For example, the determination unit 43 may determine that the evaluation value E(n) has satisfied the requirement R(n) if the evaluation value E(n) exceeds the threshold TH(n), and determine that the evaluation value E(n) has not satisfied the requirement R(n) if the evaluation value E(n) does not reach the evaluation value E(n).

Note that, if two or more of the psychological statuses PS, the two or more being in ranks higher than that of the current psychological status CS and in the same rank as each other, can each be determined as a new current-psychological status CS (for example, if the psychological statuses PS-5 and PS-6 in FIG. 3 can each be determined as a new current-psychological status CS), the determination unit 43 may determine that one of the two or more of the psychological statuses PS is the new current-psychological status CS on the basis of a proportion of the evaluation value E(n) to the threshold TH(n) (E(n)/TH(n)). Specifically, the determination unit 43 may calculate the proportions (E(n)/TH(n)) respectively for the two or more of the psychological statuses PS, compare the calculated proportions (E(n)/TH(n)) of the two or more psychological statuses PS to each other, and determine that one of the two or more psychological statuses PS (for example, one with a highest one of the proportions) is the new current-psychological statuses CS on the basis of results of the comparison. It is conceivable that the proportion (E(n)/TH(n)) of the evaluation value E(n) to the threshold TH(n) indicates a level of achievement of the requirement R(n). Thus, even when the functions of the evaluation values E(n) differ from psychological status PS to psychological status PS, by comparing the proportions of these evaluation values E(n) to each other, the current psychological status CS can be determined more appropriately from among the two or more of the psychological statuses PS.

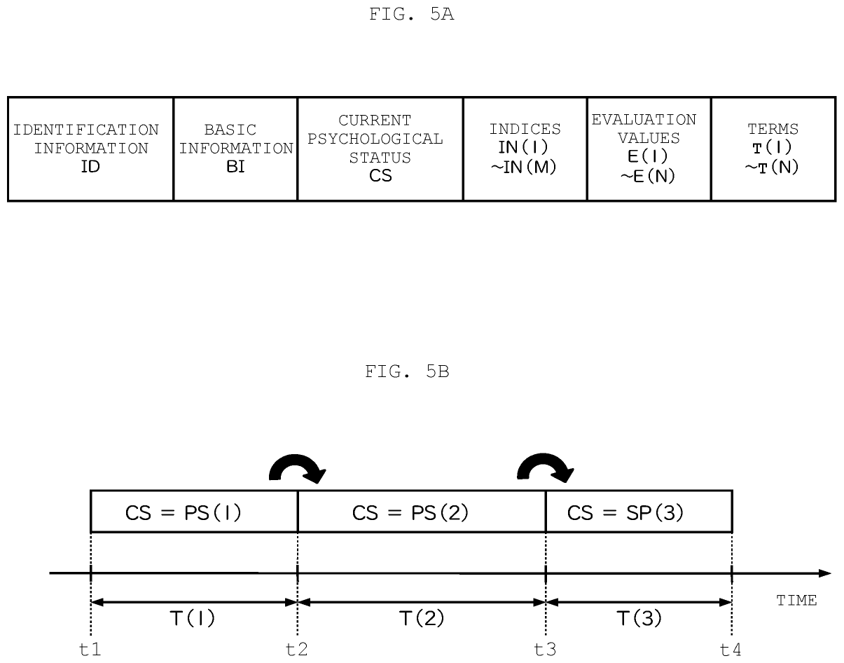

FIG. 5A is a chart showing an example of a configuration of a record to be recorded in the database 51. The record shown in FIG. 5A is a group of data to be recorded of each of the targets, which includes identification information ID, basic information BI, information indicating the current psychological status CS, “M” indices IN (1) to IN(M), “N” evaluation values E(1) to E(N), and “N” terms T(1) to T(N).

The identification information ID is information for identifying each of the targets. The basic information BI includes basic information about the target, such as the name of the target, the name of his/her company, his/her e-mail address, gender, and postal address.

The information indicating the current psychological status CS is information indicating which of “N” psychological statuses PS(1) to PS(N) the current psychological status CS is. This information includes numbers n(1≤n≤N) representing the rank of the psychological status PS(n).

The “M” indices IN(1) to IN(M) are “M” numerical values, each of which is calculated on the basis of the target information by the index calculation unit 42. The number of the indices IN to be calculated by the index calculation unit 42 may be two or more (M≥2), or may be one (M=1).

The “N” evaluation values E(1) to E(N) are “N” numerical values that are calculated corresponding to the “N” psychological statuses PS(1) to PS(N) by the determination unit 43.

As shown in FIG. 5B, the terms T(1) to T(N) represent terms in which the “N” psychological statuses PS(1) to PS(N) are determined as the current psychological status CS. In other words, a term T(n) represents a term in which the psychological status PS(n) is determined as the current psychological status CS. For example, the term T(n) includes information about a first date and a last date when the psychological status PS(n) is determined as the current psychological status CS.

The information providing unit 44 selects and provides appropriate information that promotes the development of the psychological status PS to each of the targets in accordance with results of the determination of the current psychological status CS by the determination unit 43. For example, the information providing unit 44 selects the appropriate information in accordance with the current psychological status CS (such as advertisements, coupons, news articles, and recommended information), and provides such information to the target by means such as e-mails.

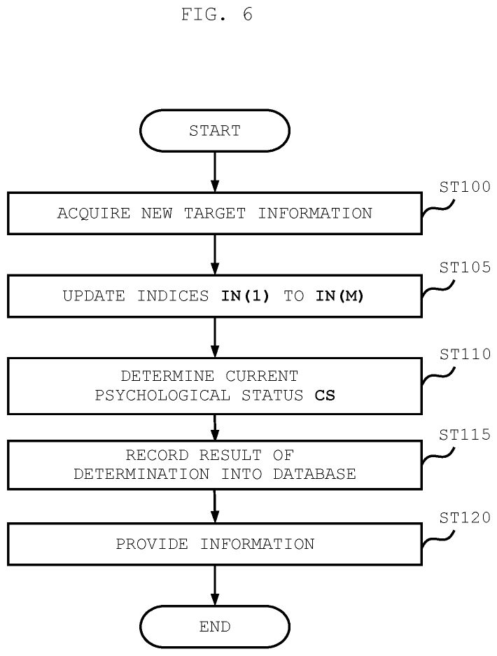

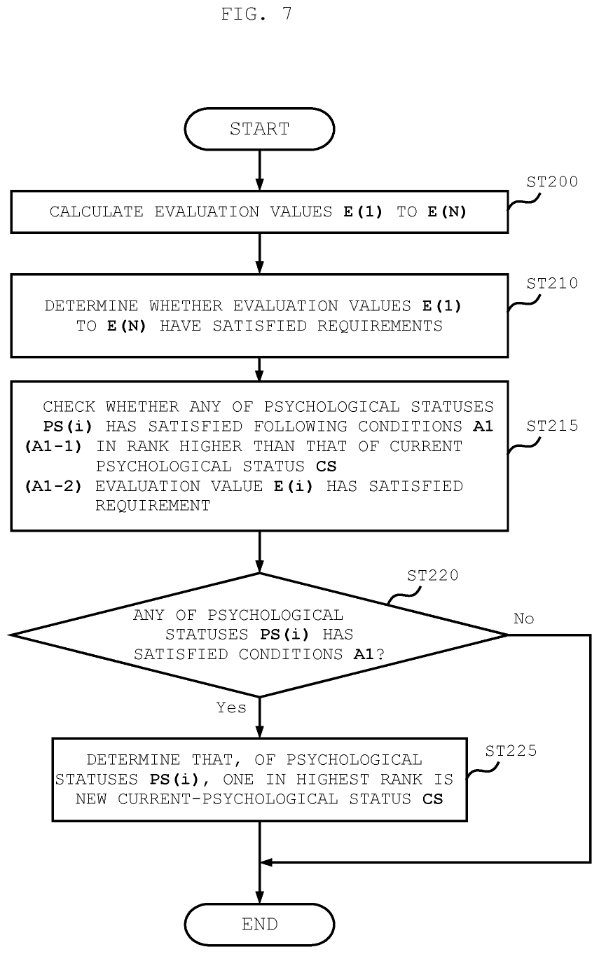

Next, operation of the information processing device 1 according to the first embodiment, which has the above-described configuration, is described with reference to flowcharts of FIG. 6 and FIG. 7.

FIG. 6 is an explanatory flowchart of a procedure for determining the psychological statuses PS of the target on the basis of the target information in the information processing device 1 according to the first embodiment. The procedure shown in FIG. 6 may be automatically executed, for example, in a predetermined cycle, or may be executed every time the information acquisition unit 41 acquires new target information.

First, the information acquisition unit 41 of the information processing device 1 acquires new target information by making access to the WEB analysis device 5 or the data collection device 6 (ST100).

After the information acquisition unit 41 acquires the new target information, the index calculation unit 42 of the information processing device 1 calculates the indices IN(1) to IN(M) on the basis of the acquired new-target information, and records these indices into the database 51 (ST105). Note that, in accordance with the acquired new-target information, the index calculation unit 42 may newly calculate (update) some of the “M” indices IN(1) to IN(M), or may newly calculate (update) all of the “M” indices IN(1) to IN(M).

After the index calculation unit 42 updates some or all of the indices IN(1) to IN(M), the determination unit 43 of the information processing device 1 determines, on the basis of the updated indices IN(1) to IN(M), which of the “N” psychological statuses PS(1) to PS(N) the current psychological status CS is (ST110). The determination unit 43 records the determined current-psychological status CS into the database 51 (ST115). On the basis of results of this determination, the determination unit 43 maintains the current psychological status CS, or determines that the psychological status PS in a rank higher or lower than that of the current psychological status CS is the new current-psychological status CS.

After the determination unit 43 determines the current psychological status CS, the information providing unit 44 of the information processing device 1 selects the appropriate information (such as advertisements) in accordance with the current psychological status CS, and provides the selected information to a corresponding one of the targets by means such as e-mails (ST120).

FIG. 7 is an explanatory flowchart showing an example of a procedure in the determination unit 43 of the information processing device 1 according to the first embodiment (Step ST110 in FIG. 6).

First, the determination unit 43 calculates the “N” evaluation values E(1) to E(N) corresponding to the “N” psychological statuses PS(1) to PS(N) on the basis of the indices IN(1) to IN(M) updated by the index calculation unit 42 (ST200). Note that, if some of the “M” indices IN are updated, the determination unit 43 may calculate, of the evaluation values E, only ones that are the values of functions that use the updated ones of the indices IN as variables.

After the determination unit 43 calculates the evaluation values E(1) to E(N) on the basis of the updated ones of the indices IN(1) to IN(M), the determination unit 43 determines whether the calculated evaluation values E(1) to E(N) have respectively satisfied a predetermined requirement R(1) to the predetermined requirement R(n) (ST210). For example, the determination unit 43 compares the evaluation value E(n) to the predetermined threshold TH(n), and determines whether the evaluation value E(n) has satisfied the requirement R(n) on the basis of the results of the comparison (ST210).

Then, the determination unit 43 checks whether any of psychological statuses PS(i) (“i” is an integer number from 1 to N) of the “N” psychological statuses PS(1) to PS(N) has satisfied the following conditions A1-1 and A1-2 (ST215).

Condition A1-1:

The psychological status PS(i) is in a rank higher than that of the current psychological status CS.

Condition A1-2:

An evaluation value E(i) corresponding to the psychological status PS(i) has satisfied a requirement R(i).

If none of the psychological statuses PS(i) has satisfied the conditions A1-1 and A1-2 (No in ST220), the determination unit 43 maintains the current psychological status CS. Meanwhile, if one or more of the psychological statuses PS(i) have satisfied the conditions A1-1 and A1-2 (Yes in ST220), the determination unit 43 determines that, of these psychological statuses PS(i), one in a highest rank is the new current-psychological status CS (ST225).

Note that, if two or more of the psychological statuses PS(i) have satisfied the conditions A1-1 and A1-2 and been in the highest rank, the determination unit 43 calculates proportions (E(i)/TH(i)) of the evaluation value E(i) to a threshold TH(i) respectively for the two or more of the psychological statuses PS(i), and compares the calculated proportions (E(i)/TH(i)) of the two or more of the psychological statuses PS(i) to each other. On the basis of results of the comparison of these proportions, the determination unit 43 determines that one of the two or more of the psychological statuses PS(i) (for example, one with a highest one of the proportions) is the new current-psychological status CS.

As described above, by the information processing device 1 according to the first embodiment, the indices IN(1) to IN(M) about the actions or the reactions by the target are calculated on the basis of the target information about the target, and, on the basis of the calculated indices IN(1) to IN(M), one of the psychological statuses PS(1) to PS(N) that shift in a stepwise manner is determined as the current psychological status CS of the target. Thus, on the basis of various information items acquired from the target, the shifts between the psychological statuses of the target can be clearly grasped.

In addition, by the information processing device 1 according to the first embodiment, if a corresponding at least one of the updated one or more indices IN has satisfied the requirement R(i) corresponding to the psychological status PS(i) in a rank higher than that of the current psychological status CS to be stored in the storage unit 50, this “psychological status PS(i) in the higher rank” is determined as the new current-psychological status CS. With this, when it is assumed that the psychological statuses PS shift differently before and after the psychological status PS reaches the “psychological status PS(i) in the higher rank,” this difference can be reflected in the determination of the current psychological status CS. For example, when it is assumed that a stage of the psychological status PS does not regress, as shown in the flowchart of FIG. 7, the psychological status PS can be prevented from shifting from a higher rank to a lower rank. Thus, even when it is assumed that the psychological status PS of the target shifts in a stepwise manner in accordance with a scenario of predetermined psychological transformation, this psychological status PS can be appropriately determined in accordance with the current psychological status CS.

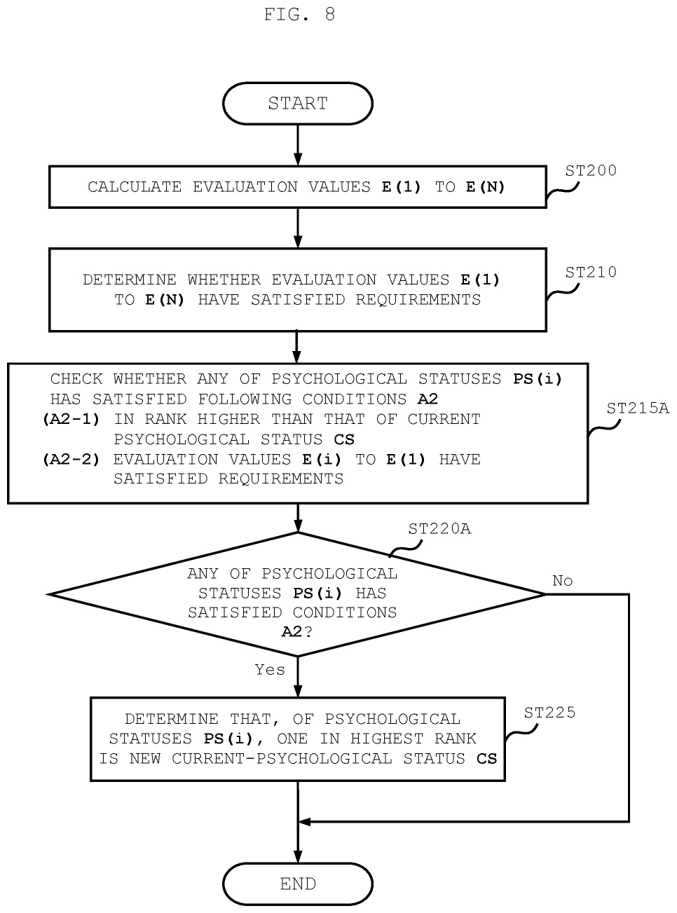

Next, some modifications of the information processing device 1 according to the first embodiment are described with reference to flowcharts of FIG. 8 to FIG. 11.

(First Modification of First Embodiment)

FIG. 8 is an explanatory flowchart showing a first modification of the procedure in the determination unit 43 of the information processing device 1 according to the first embodiment. The flowchart shown in FIG. 8 is different from the flowchart shown in FIG. 7 only in that Step ST215 and Step ST220 in FIG. 7 are replaced with Step ST215A and Step ST220A. The other steps in the flowchart shown in FIG. 8 are the same as those in the flowchart shown in FIG. 7.

In the information processing device 1 of the first modification, if a corresponding at least one of the indices IN(1) to IN(M) updated by the index calculation unit 42 has satisfied the requirement R(i) corresponding to the psychological status PS(i) in a rank higher than that of the current psychological status CS, and has satisfied a series of a requirement R(i−1) to the requirement R(1) corresponding to a series of a psychological status PS(i−1) to the psychological status PS(1) in ranks lower than that of the psychological status PS(i), the determination unit 43 determines that the psychological status PS(i) is the new current-psychological status CS. In other words, if the evaluation value E(i) corresponding to the psychological status PS(i) in the rank higher than that of the current psychological status CS has satisfied the requirement R(i), and if an evaluation value E(i−1) to the evaluation value E(1) in series, which correspond to the psychological statuses PS(i−1) to PS(1) in series and in the ranks lower than that of the psychological status PS(i), have respectively satisfied the requirements R(i−1) to R(1) in series, the determination unit 43 determines that the psychological status PS(i) is the new current-psychological status CS.

As shown in the flowchart of FIG. 8, in Step ST215A, the determination unit 43 checks whether any of the psychological statuses PS(i) of the “N” psychological statuses PS(1) to PS(N) has satisfied the following conditions A2-1 and A2-2. The condition A2-1 is the same as the condition A1-1, and the condition A2-2 is different from the condition A1-2.

Condition A2-1:

The psychological status PS(i) is in a rank higher than that of the current psychological status CS.

Condition A2-2:

Evaluation values E(i) to E(1) corresponding to the psychological statuses PS(i) to PS(1) have respectively satisfied the requirements R(i) to R(1).

If none of the psychological statuses PS(i) has satisfied the conditions A2-1 and A2-2 (No in ST220A), the determination unit 43 maintains the current psychological status CS. Meanwhile, if one or more of the psychological statuses PS(i) have satisfied the conditions A2-1 and A2-2 (Yes in ST220A), the determination unit 43 determines that, of these psychological statuses PS(i), one in a highest rank is the new current-psychological status CS (ST225).

The condition A1-2 of Step ST215 (FIG. 7) is that only the evaluation value E(i) corresponding to the psychological status PS(i) has satisfied the requirement R(i). In contrast, the condition A2-2 of Step ST215A (FIG. 8) is that not only the evaluation value E(i) corresponding to the psychological status PS(i) needs to satisfy the requirement R(i), but also the evaluation values E(i−1) to E(1) corresponding to the psychological statuses PS(i−1) to PS(1) in ranks lower than that of the psychological status PS(i) need to respectively satisfy the requirements R(i−1) to R(1).

For example, in the determination procedure of the flowchart shown in FIG. 7, if the current psychological status CS is a psychological status PS(2), even when the evaluation value E(3) corresponding to a psychological status PS(3) in a rank higher than that of the psychological status PS(2) has not satisfied a requirement R(3), as long as the evaluation value E(4) corresponding to a psychological status PS(4) in a much higher rank has satisfied a requirement (4), it is possible to determine that the psychological status PS(4) is the new current-psychological status CS. In contrast, in the determination procedure of the flowchart shown in FIG. 8, it is impossible to determine that the psychological status PS(4) is the new current-psychological status CS unless the evaluation value E(4) corresponding to the psychological status PS(4) in a highest rank has satisfied the requirement R(4), and unless the evaluation values E(3) to E(1) corresponding to the psychological statuses PS(3) to PS(1) in ranks lower than that of the psychological status PS(4) have respectively satisfies the requirements R(3) to R(1).

In a scenario of psychological transformation assumed from the “N” psychological statuses PS, even under a state in which psychological statuses PS in lower ranks have not satisfied the requirements R, if it is natural that the psychological status PS shift to ones in higher ranks, it is preferred that the current psychological status CS be determined as in the flowchart shown in FIG. 7. Meanwhile, in the scenario of the psychological transformation assumed from the “N” psychological statuses PS, if it is natural to satisfy the requirements R sequentially from those corresponding to the psychological statuses PS in lower ranks to those corresponding to the psychological statuses PS in higher ranks, it is preferred that the current psychological status CS be determined as in the flowchart of the first modification shown in FIG. 8.

(Second Modification of First Embodiment)

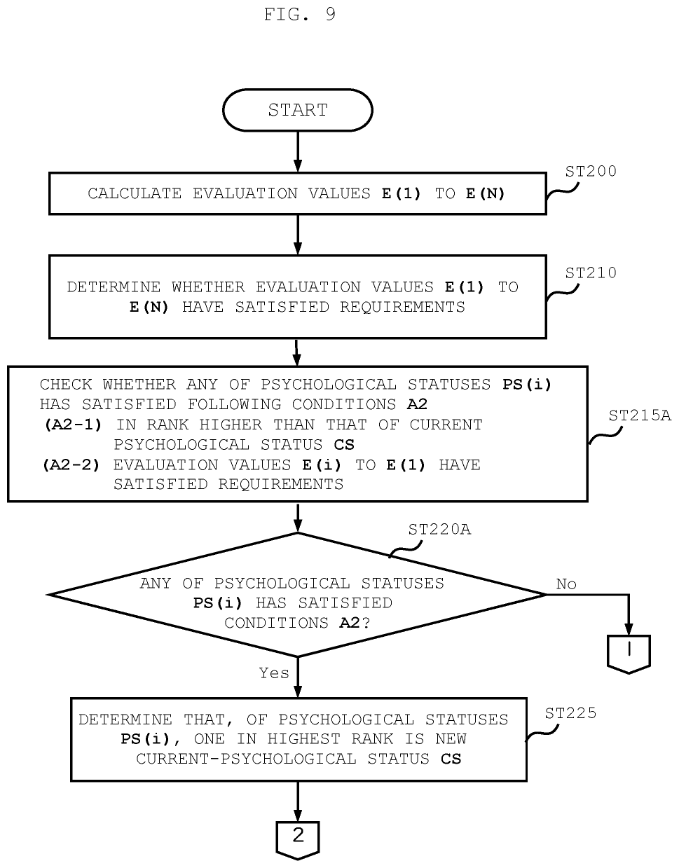

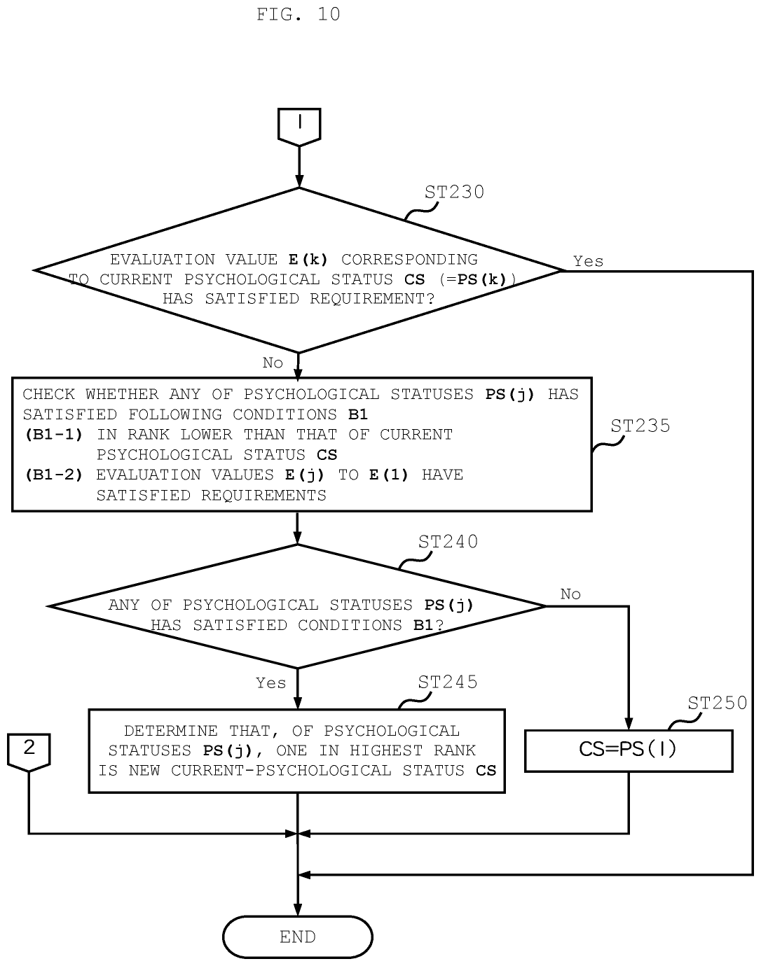

FIG. 9 and FIG. 10 are explanatory flowcharts showing a second modification of the procedure in the determination unit 43 of the information processing device 1 according to the first embodiment. Steps ST200 to ST225 in the flowchart shown in FIG. 9 are the same as Steps denoted by the same reference numbers in the flowchart of the first modification shown in FIG. 8. The determination unit 43 of the second modification is different from the determination unit 43 of the first modification (FIG. 8) in executing processes of Step ST230 and subsequent steps shown in FIG. 10 if determining in Step ST220A that none of the psychological statuses PS(i) has satisfied the conditions A2-1 and A2-2 (No in ST220A).

In the information processing device 1 of the second modification, if none of the indices IN(1) to IN(M) updated by the index calculation unit 42 has satisfied the requirement R corresponding to the current psychological status CS, the determination unit 43 determines that the psychological status PS in a rank lower than that of the current psychological status CS is the new current-psychological status CS. In other words, if the evaluation value E corresponding to the current psychological status CS has not satisfied the requirement R, the determination unit 43 determines that the psychological status PS in the rank lower than that of the current psychological status CS is the new current-psychological status CS.

If it is determined that none of the psychological statuses PS(i) has satisfied the conditions A2-1 and A2-2 (No in ST220A), the determination unit 43 determines whether or not an evaluation value E(k) corresponding to the current psychological status CS (a psychological status PS(k)) has satisfied a requirement R(k) (ST230). If the evaluation value E(k) has satisfied the requirement R(k) (Yes in ST230), the determination unit 43 maintains the current psychological status CS. Meanwhile, if the evaluation value E(k) has not satisfied the requirement R(k) (No in ST230), the determination unit 43 checks whether any of psychological statuses PS(j) has satisfied the following conditions B1-1 and B1-2 (ST235).

Condition B1-1:

The psychological status PS(j) is in a rank lower than that of the current psychological status CS (j<k).

Condition B1-2:

An evaluation value E(j) to the evaluation value E(1) corresponding to the psychological statuses PS(j) to PS(1) have respectively satisfied a requirement R(j) to the requirement R(1).

If any of the psychological statuses PS(j) has satisfied the conditions B1-1 and B1-2 (Yes in ST240), the determination unit 43 determines that, of the psychological statuses PS(j), one in a highest rank is the new current-psychological status CS (ST245). Meanwhile, if none of the psychological statuses PS(j) has satisfied the conditions B1-1 and B1-2 (No in ST240), the determination unit 43 determines that the psychological status PS(1) in a lowest rank is the new current-psychological status CS (ST250).

In the scenario of the psychological transformation assumed from the “N” psychological statuses PS, if it is natural to satisfy the requirements R sequentially from those corresponding to the psychological statuses PS in lower ranks to those corresponding to the psychological statuses PS in higher ranks, and if it is natural to cause the psychological status PS to regress to those in lower ranks under the state in which the psychological statuses PS in lower ranks have not satisfied the requirements R, the current psychological status CS can be determined appropriately by the flowcharts of the second modification shown in FIG. 9 and FIG. 10.

(Third Modification of First Embodiment)

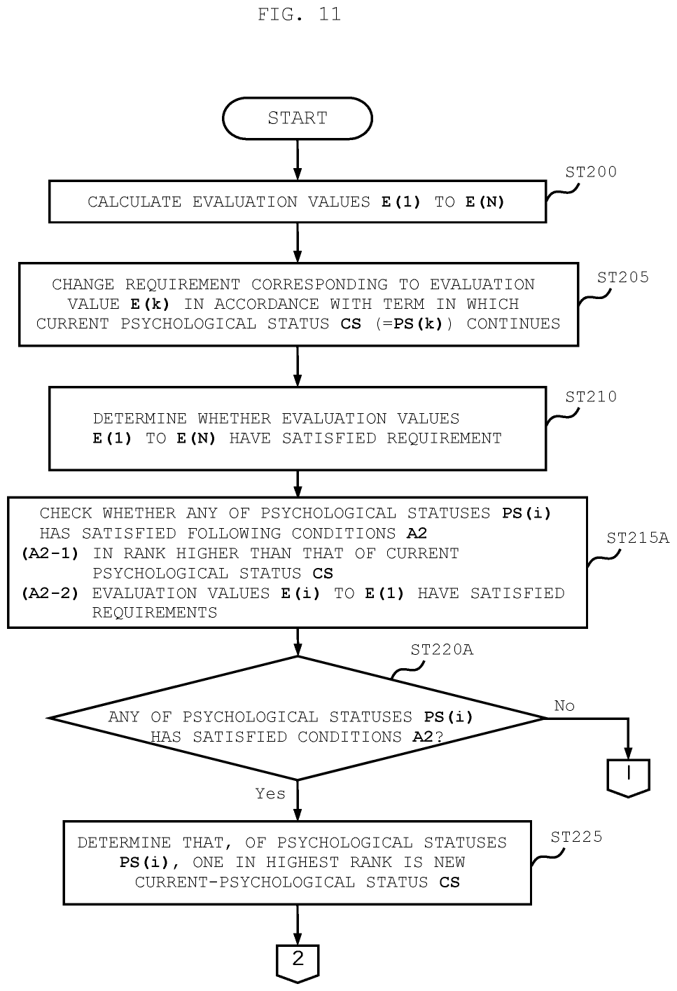

FIG. 11 is an explanatory flowchart showing a third modification of the procedure in the determination unit 43 of the information processing device 1 according to the first embodiment. The flowchart shown in FIG. 11 is different from the flowchart of the second modification shown in FIG. 9 only in that Step ST205 is added between Step ST200 and Step ST210. The other steps in the flowchart shown in FIG. 11 are the same as those in the flowchart shown in FIG. 9.

In Step ST205, the determination unit 43 changes the requirement R(k) corresponding to one of the psychological statuses PS(k) in accordance with a term T(k) in which the one of the psychological statuses PS(k) is determined as the current psychological status CS. For example, if the term T(k) corresponding to the current psychological status CS (psychological status PS(k)) continues longer than a predetermined period, the determination unit 43 changes the requirement R(k) such that the evaluation value E(k) corresponding to the current psychological status CS (psychological status PS(k)) is prevented from satisfying the requirement R(k). With this, if a situation in which it is difficult for the current psychological status CS to shift to the psychological statuses PS in higher ranks continues long, the current psychological status CS easily regresses to the psychological statuses PS in lower ranks. Thus, if a rank of the current psychological status CS is likely to be higher than a rank that is supposed to be a rank of an appropriate one of the psychological statuses PS, the current psychological status CS can be flexibly corrected to the appropriate one of the psychological statuses PS.

### Second Embodiment

Next, the information processing device 1 according to a second embodiment of the present invention is described. The information processing device 1 according to the second embodiment is different from the information processing device 1 according to the first embodiment in that the determination unit 43 executes a different procedure. Other configuration features of the information processing device 1 according to the second embodiment are the same as those of the information processing device 1 according to the first embodiment. Below, the difference from the first embodiment, that is, the procedure in the determination unit 43 is mainly described.

In the information processing device 1 according to the second embodiment, if a corresponding at least one of the indices IN(1) to IN(M) updated by the index calculation unit 42 has satisfied the requirement R(k) corresponding to the current psychological status CS (psychological status PS(k)), and has satisfied a series of a requirement R(k−1) to the requirement R(1) corresponding to a series of a psychological status PS(k−1) to the psychological status PS(1) in ranks lower than that of the current psychological status CS, the determination unit 43 determines that a psychological status PS(k+1) in a rank higher than that of the current psychological status CS is the new current-psychological status CS. In other words, if the evaluation value E(k) corresponding to the current psychological status CS (psychological status PS(k)) has satisfied the requirement R(k), and if an evaluation value E(k−1) to the evaluation value E(1) in series, which correspond to the psychological statuses PS(k−1) to PS(1) in series and in the ranks lower than that of the current psychological status CS, have respectively satisfied the requirements R(k−1) to R(1) in series, the determination unit 43 determines that the psychological status PS(k+1) in the rank higher than that of the current psychological status CS is the new current-psychological status CS.

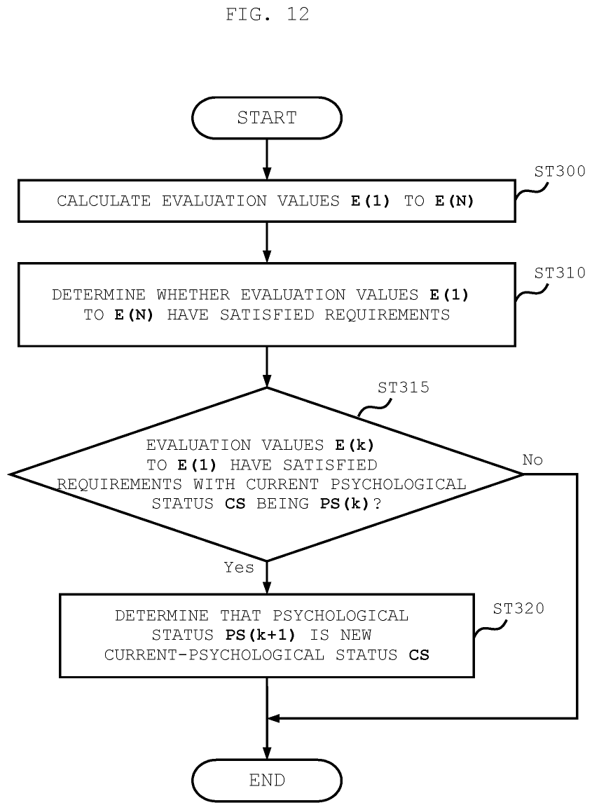

FIG. 12 is an explanatory flowchart showing an example of a procedure in the determination unit 43 of the information processing device 1 according to the second embodiment.

First, the determination unit 43 calculates the “N” evaluation values E(1) to E(N) corresponding to the “N” psychological statuses PS(1) to PS(N) on the basis of the indices IN(1) to IN(M) updated by the index calculation unit 42 (ST300). Then, the determination unit 43 determines whether the calculated evaluation values E(1) to E(N) have respectively satisfied the predetermined requirements R(1) to R(n) (ST310). Steps ST300 and ST310 are the same as Steps ST200 and ST210 in the flowchart shown in FIG. 7.

Next, the determination unit 43 determines whether or not the evaluation values E(k) to E(1) corresponding to the current psychological status CS (psychological status PS(k)) and to the psychological statuses PS(k−1) to PS(1) in ranks lower than that of the current psychological status CS (psychological status PS(k)) have respectively satisfied the requirements R(k) to R(1) (ST315). If an at least one of the evaluation values E(k) to E(1) has not satisfied a corresponding one of the requirements R(k) to R(1), the determination unit 43 maintains the current psychological status CS (No in ST315).

Meanwhile, if the evaluation values E(k) to E(1) have respectively satisfied the requirements R(k) to R(1) (Yes in ST315), the determination unit 43 determines that the psychological status PS(k+1) in a rank higher by one than that of the current psychological status CS (psychological status PS(k)) is the new current-psychological status CS.

As described above, in the information processing device 1 according to the second embodiment, if the requirements R corresponding to the psychological statuses PS in a series of lower ranks have been satisfied, the current psychological status CS shifts to the psychological statuses PS in higher ranks. Thus, in the scenario of the psychological transformation assumed from the “N” psychological statuses PS, if it is natural to satisfy the requirements R sequentially from those corresponding to the psychological statuses PS in lower ranks to those corresponding to the psychological statuses PS in higher ranks, the current psychological status CS can be appropriately determined.

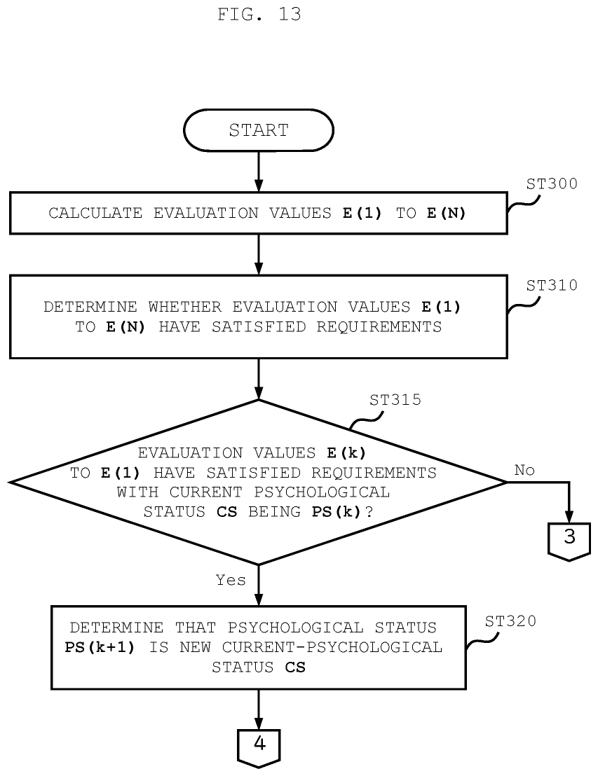

Next, some modifications of the information processing device 1 according to the second embodiment are described with reference to flowcharts of FIG. 13 to FIG. 15.

(First Modification of Second Embodiment)

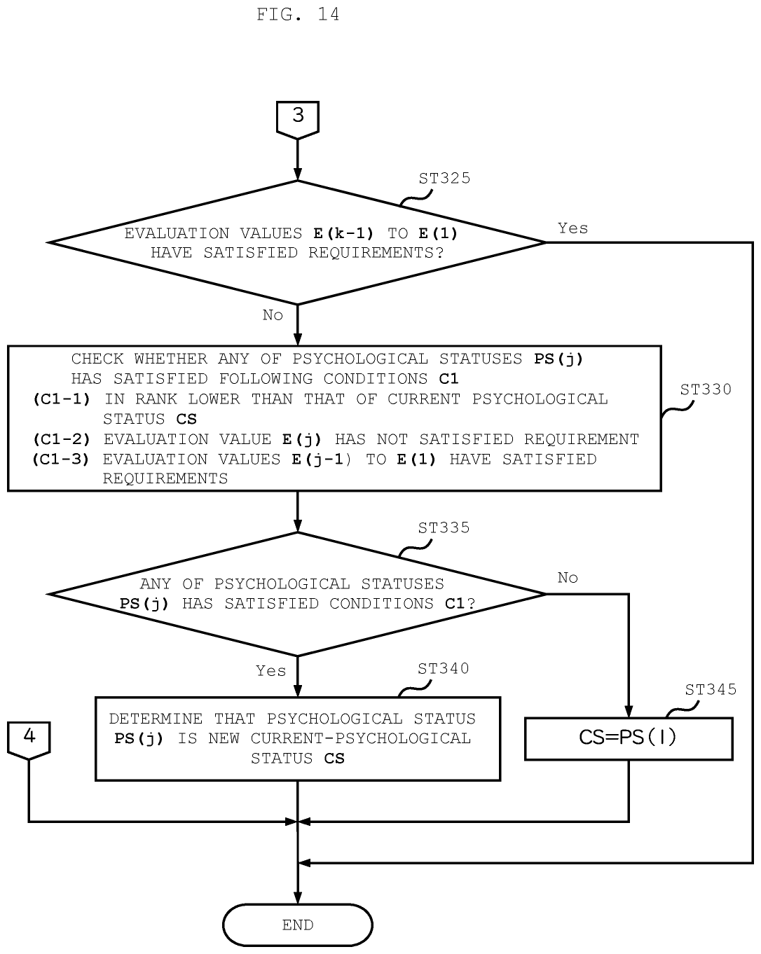

FIG. 13 and FIG. 14 are explanatory flowcharts showing a first modification of the procedure in the determination unit 43 of the information processing device 1 according to the second embodiment. Steps ST300 to ST320 in the flowchart shown in FIG. 13 are the same as Steps denoted by the same reference numbers in the flowchart of the first modification shown in FIG. 12. The determination unit 43 of the first modification is different from the determination unit 43 that executes the procedure of the flowchart shown in FIG. 12 in executing processes of Step ST325 and subsequent steps shown in FIG. 14 if determining in Step ST315 that an at least one of the evaluation values E(k) to E(1) has not satisfied a corresponding one of the requirements R(k) to R(1) (No in ST315).

In the information processing device 1 of the first modification, if a corresponding at least one of the indices IN(1) to IN(M) updated by the index calculation unit 42 has not satisfied the requirement R corresponding to the psychological status PS in a rank lower than that of the current psychological status CS, the determination unit 43 determines that the psychological status PS in the lower rank is the new current-psychological status CS. In other words, if the evaluation value E corresponding to the psychological status PS in the rank lower than that of the current psychological status CS has not satisfied the requirement R, the determination unit 43 determines that the psychological status PS in the lower rank is the new current-psychological status CS.

If it is determined that the at least one of the evaluation values E(k) to E(1) has not satisfied the corresponding one of the requirements R(k) to R(1) (No in ST315), the determination unit 43 determines whether or not the evaluation values E(k−1) to E(1) have respectively satisfied the requirements R(k−1) to R(1) (ST325). If the evaluation values E(k−1) to E(1) have respectively satisfied the requirements R(k−1) to R(1) (Yes in ST325), the determination unit 43 maintains the current psychological status CS. Meanwhile, if the at least one of the evaluation values E(k−1) to E(1) has not satisfied the corresponding one of the requirements R(k−1) to R(1) (No in ST325), the determination unit 43 checks whether any of the psychological statuses PS(j) has satisfied the following conditions C1-1, C1-2, and C1-3 (ST330).

Condition C1-1:

The psychological status PS(j) is in a rank lower than that of the current psychological status CS (j<k).

Condition C1-2:

The evaluation value E(j) corresponding to the psychological status PS(j) has not satisfied the requirement R(j).

Condition C1-3:

An evaluation value E(j-1) to the evaluation value E(1) corresponding to a psychological status PS(j-1) to the psychological status PS(1) have respectively satisfied a requirement R(j-1) to the requirement R(1).

If any of the psychological statuses PS(j) has satisfied the conditions C1-1, C1-2, and C1-3 (Yes in ST335), the determination unit 43 determines that the any of the psychological status PS(j) is the new current-psychological status CS (ST340). Meanwhile, if none of the psychological statuses PS(j) has satisfied the conditions C1-1, C1-2, and C1-3 (No in ST335), the determination unit 43 determines that the psychological status PS(1) in the lowest rank is the new current-psychological status CS (ST345).

In the scenario of the psychological transformation assumed from the “N” psychological statuses PS, if it is natural to satisfy the requirements R sequentially from those corresponding to the psychological statuses PS in lower ranks to those corresponding to the psychological statuses PS in higher ranks, and if it is natural to cause the psychological status PS to regress to those in lower ranks under the state in which the psychological statuses PS in lower ranks have not satisfied the requirements R, the current psychological status CS can be determined appropriately by the flowcharts of the first modification shown in FIG. 13 and FIG. 14.

(Second Modification of Second Embodiment)

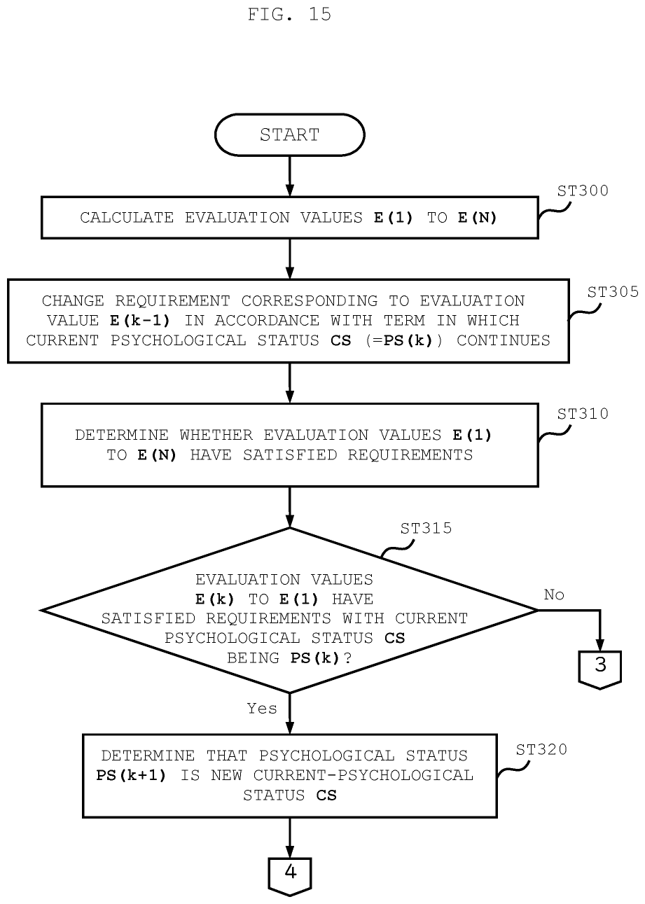

FIG. 15 is an explanatory flowchart showing a second modification of the procedure in the determination unit 43 of the information processing device 1 according to the second embodiment. The flowchart shown in FIG. 15 is different from the flowchart of the first modification shown in FIG. 13 only in that Step ST305 is added between Step ST300 and Step ST310. The other steps in the flowchart shown in FIG. 15 are the same as those in the flowchart shown in FIG. 13.

In Step ST305, the determination unit 43 changes the requirement R(k−1) corresponding to the psychological status PS(k−1) in a rank lower than one of the psychological statuses PS(k) in accordance with the term T(k) in which the one of the psychological statuses PS(k) is determined as the current psychological status CS. For example, if the term T(k) corresponding to the current psychological status CS (psychological status PS(k)) continues longer than a predetermined period, the determination unit 43 changes the requirement R(k−1) such that the evaluation value E(k−1) corresponding to the psychological status PS(k−1) in a rank lower than the current psychological status CS (psychological status PS(k)) is prevented from satisfying the requirement R(k−1). With this, if a situation in which it is difficult for the current psychological status CS to shift to the psychological statuses PS in higher ranks continues long, the current psychological status CS easily regresses to the psychological statuses PS in lower ranks. Thus, if a rank of the current psychological status CS is likely to be higher than a rank that is supposed to be a rank of an appropriate one of the psychological statuses PS, the current psychological status CS can be flexibly corrected to the appropriate one of the psychological statuses PS.

Note that, the technology disclosed herein is not limited only to the above-described embodiments, and may include other variations.

For example, the technology disclosed herein is not limited to the example in which, in the flowchart shown in FIG. 12, if the evaluation values E(k) to E(1) corresponding to the current psychological status CS (psychological status PS(k)) and to the psychological statuses PS(k−1) to PS(1) in ranks lower than that of the current psychological status CS (psychological status PS(k)) have respectively satisfied the requirements R(k) to R(1) (Yes in ST315), the determination unit 43 determines that the psychological status PS(k+1) in a rank higher by one than that of the current psychological status CS (psychological status PS(k)) is the new current-psychological status CS (ST320). As another example of the technology disclosed herein, if only the evaluation value E(k) corresponding to the current psychological status CS (psychological status PS(k)) has satisfied the requirement R(k), the procedure may proceed to Step ST320 (FIG. 12), and the determination unit 43 may determine that the psychological status PS(k+1) in the higher rank is the new current-psychological status CS. Also in this case, even when it is assumed that the psychological status PS of the target shifts in a stepwise manner in accordance with the scenario of the predetermined psychological transformation, this psychological status PS can be appropriately determined in accordance with the current psychological status CS.

Below, Appendices [A1] to [A16] and [B1] to [B10] relating to the technology disclosed herein are described.

[Appendix A1] An information processing device, including:

an information acquisition unit (41) configured to acquire target information about a target;

an index calculation unit (42) configured to calculate an at least one index of one of actions and reactions by the target on the basis of the target information acquired by the information acquisition unit (41);

a storage unit (50); and

a determination unit (43)
configured to determine a current psychological status of the target on the basis of the at least one index calculated by the index calculation unit (42), and
configured to store the current psychological status after the determination into the storage unit (50),

in which the current psychological status to be determined by the determination unit (43) is one of a plurality of psychological statuses that shift in a stepwise manner,

in which a plurality of requirements corresponding to the plurality of psychological statuses are defined,

in which the plurality of requirements are each a requirement to be satisfied by the at least one index,

in which the index calculation unit (42) updates the at least one index on the basis of the target information after the acquisition by the information acquisition unit (41), and

in which, if the at least one index updated by the index calculation unit (42) has satisfied one requirement of the plurality of requirements, the one requirement corresponding to another one psychological status of the plurality of psychological statuses, the other one psychological status being in a rank higher than a rank of the current psychological status to be stored in the storage unit (50), the determination unit (43) determines that the other one psychological status in the higher rank is a new current-psychological status.

[Appendix A2] The information processing device according to Appendix A1,

in which, if the at least one index after the update
has satisfied the one requirement that corresponds to the other one psychological status in the rank higher than the rank of the current psychological status to be stored in the storage unit (50), and
has satisfied a series of requirements of the plurality of requirements, the series of requirements corresponding to a series of psychological statuses of the plurality of psychological statuses, the series of psychological statuses being in ranks lower than the rank of the other one psychological status in the higher rank, the determination unit (43) determines that the other one psychological status in the higher rank is the new current-psychological status.
   [Appendix A3] The information processing device according to Appendix A2,

in which, if the at least one index after the update has been prevented from satisfying another one requirement of the plurality of requirements, the other one requirement corresponding to the current psychological status to be stored in the storage unit (50), the determination unit (43) determines that a still another one psychological status of the plurality of psychological statuses is the new current-psychological status, the still other one psychological status being in a rank lower than the rank of the current psychological status and having satisfied a corresponding one requirement of the plurality of requirements.

[Appendix A4] The information processing device according to Appendix A3,

in which the determination unit (43) changes, of the plurality of requirements, an at least one requirement that corresponds to an at least one psychological status of the plurality of psychological statuses in accordance with a term in which the at least one psychological status is determined as the current psychological status.

[Appendix A5] An information processing device, including:

an information acquisition unit (41) configured to acquire target information about a target;

an index calculation unit (42) configured to calculate an at least one index of one of actions and reactions by the target on the basis of the target information acquired by the information acquisition unit (41);

a storage unit (50); and

a determination unit (43)
configured to determine a current psychological status of the target on the basis of the at least one index calculated by the index calculation unit (42), and
configured to store the current psychological status after the determination into the storage unit (50),

in which the current psychological status to be determined by the determination unit (43) is one of a plurality of psychological statuses that shift in a stepwise manner,

in which a plurality of requirements corresponding to the plurality of psychological statuses are defined,

in which the plurality of requirements are each a requirement to be satisfied by the at least one index,

in which the index calculation unit (42) updates the at least one index on the basis of the target information after the acquisition by the information acquisition unit (41), and

in which, if the at least one index updated by the index calculation unit (42) has satisfied one requirement of the plurality of requirements, the one requirement corresponding to the current psychological status to be stored in the storage unit (50), the determination unit (43) determines that another one psychological status of the plurality of psychological statuses is a new current-psychological status, the other one psychological status being in a rank higher than a rank of the current psychological status.

[Appendix A6] The information processing device according to Appendix A5,

in which, if the at least one index after the update
has satisfied the one requirement that corresponds to the current psychological status to be stored in the storage unit (50), and
has satisfied a series of requirements of the plurality of requirements, the series of requirements corresponding to a series of psychological statuses of the plurality of psychological statuses, the series of psychological statuses being in ranks lower than the rank of the current psychological status, the determination unit (43) determines that the other one psychological status in the rank higher than the rank of the current psychological status is the new current-psychological status.
   [Appendix A7] The information processing device according to Appendix A6,

in which, if the at least one index after the update has been prevented from satisfying another one requirement of the plurality of requirements, the other one requirement corresponding to a still another one psychological status of the plurality of psychological statuses, the still other one psychological status being in a rank lower than the rank of the current psychological status to be stored in the storage unit (50), the determination unit (43) determines that the still other one psychological status in the lower rank is the new current-psychological status.

[Appendix A8] The information processing device according to Appendix A7,

in which the determination unit (43) changes, of the plurality of requirements, of the plurality of requirements, an at least one requirement that corresponds to an at least one psychological status of the plurality of psychological statuses in accordance with a term in which another at least one psychological status is determined as the current psychological status, the at least one psychological status being in a rank lower than a rank of the other at least one psychological status.

[Appendix A9] The information processing device according to any one of Appendices A1 to A8,

in which a plurality of evaluation values corresponding to the plurality of psychological statuses are set,

in which the plurality of evaluation values are each a value of a function that uses the at least one index as a variable, and

in which, when the determination unit (43) determines whether or not the at least one index has satisfied an at least one requirement of the plurality of requirements, the at least one requirement corresponding to an at least one psychological status of the plurality of psychological statuses, the determination unit (43)
calculates an at least one evaluation value of the plurality of evaluation values on the basis of the at least one index, the at least one evaluation value corresponding to the at least one psychological status, and
determines whether or not the at least one evaluation value after the calculation has satisfied the at least one requirement.
   [Appendix A10] The information processing device according to Appendix A9,

in which, when the determination unit (43) determines whether or not the at least one evaluation value calculated for the at least one psychological status has satisfied the at least one requirement, the determination unit (43) makes the determination on the basis of a result of comparison between the at least one evaluation value and a threshold that is set for the at least one requirement, and

in which, if at least two psychological statuses of the plurality of psychological statuses, the at least two psychological statuses being in ranks higher than the rank of the current psychological status to be stored in the storage unit (50) and in the same rank as each other, can each be determined as the new current-psychological status, the determination unit (43)
calculates proportions of at least two evaluation values of the plurality of evaluation values to thresholds respectively for at least two psychological statuses of the plurality of psychological statuses, the thresholds being set respectively for at least two requirements of the plurality of requirements,
compares the proportions calculated respectively for the at least two psychological statuses to each other, and
determines, on the basis of a result of the comparison of the proportions, that one of the at least two psychological statuses is the new current-psychological status.
   [Appendix A11] An information processing method to be executed by an at least one computer, the information processing method including:

acquiring target information about a target;

calculating an at least one index of one of actions and reactions by the target on the basis of the target information after the acquisition;

determining a current psychological status of the target on the basis of the at least one index after the calculation; and

storing the current psychological status after the determination into a storage unit (50),

in which the current psychological status is one of a plurality of psychological statuses that shift in a stepwise manner,

in which a plurality of requirements corresponding to the plurality of psychological statuses are defined,

in which the plurality of requirements are each a requirement to be satisfied by the at least one index,

in which the calculating of the at least one index includes updating the at least one index on the basis of the target information after the acquisition, and

in which the determining of the current psychological status includes determining that, of the plurality of psychological statuses, another one psychological status in a rank higher than a rank of the current psychological status to be stored in the storage unit (50) is a new current-psychological status if the at least one index after the update has satisfied one requirement of the plurality of requirements, the one requirement corresponding to the other one psychological status in the higher rank.

[Appendix A12] An information processing method to be executed by an at least one computer, the information processing method including:

acquiring target information about a target;

calculating an at least one index of one of actions and reactions by the target on the basis of the target information after the acquisition;

determining a current psychological status of the target on the basis of the at least one index after the calculation; and

storing the current psychological status after the determination into a storage unit (50),

in which the current psychological status is one of a plurality of psychological statuses that shift in a stepwise manner,

in which a plurality of requirements corresponding to the plurality of psychological statuses are defined,

in which the plurality of requirements are each a requirement to be satisfied by the at least one index,

in which the calculating of the at least one index includes updating the at least one index on the basis of the target information after the acquisition, and

in which the determining of the current psychological status includes determining that, of the plurality of psychological statuses, another one psychological status in a rank higher than a rank of the current psychological status to be stored in the storage unit (50) is a new current-psychological status if the at least one index after the update has satisfied one requirement of the plurality of requirements, the one requirement corresponding to the current psychological status.

[Appendix A13] The information processing method according to Appendix A12,

in which the determining of the current psychological status includes determining that the other one psychological status in the rank higher than the rank of the current psychological status to be stored in the storage unit (50) is the new current-psychological status if the at least one index after the update
has satisfied the one requirement that corresponds to the current psychological status, and
has satisfied a series of requirements of the plurality of requirements, the series of requirements corresponding to a series of psychological statuses of the plurality of psychological statuses, the series of psychological statuses being in ranks lower than the rank of the current psychological status.
   [Appendix A14] A non-transitory tangible recording medium that stores an at least one program for causing an at least one computer to implement an information processing method, the information processing method including:

acquiring target information about a target;

calculating an at least one index of one of actions and reactions by the target on the basis of the target information after the acquisition;

determining a current psychological status of the target on the basis of the at least one index after the calculation; and

storing the current psychological status after the determination into a storage unit (50),

in which the current psychological status is one of a plurality of psychological statuses that shift in a stepwise manner,

in which a plurality of requirements corresponding to the plurality of psychological statuses are defined,

in which the plurality of requirements are each a requirement to be satisfied by the at least one index,

in which the calculating of the at least one index includes updating the at least one index on the basis of the target information after the acquisition, and

in which the determining of the current psychological status includes determining that, of the plurality of psychological statuses, another one psychological status in a rank higher than a rank of the current psychological status to be stored in the storage unit (50) is a new current-psychological status if the at least one index after the update has satisfied one requirement of the plurality of requirements, the one requirement corresponding to the other one psychological status in the higher rank.

[Appendix A15] A non-transitory tangible recording medium that stores an at least one program for causing an at least one computer to implement an information processing method, the information processing method including:

acquiring target information about a target;

calculating an at least one index of one of actions and reactions by the target on the basis of the target information after the acquisition;

determining a current psychological status of the target on the basis of the at least one index after the calculation; and

storing the current psychological status after the determination into a storage unit (50),

in which the current psychological status is one of a plurality of psychological statuses that shift in a stepwise manner,

in which a plurality of requirements corresponding to the plurality of psychological statuses are defined,

in which the plurality of requirements are each a requirement to be satisfied by the at least one index,

in which the calculating of the at least one index includes updating the at least one index on the basis of the target information after the acquisition, and

in which the determining of the current psychological status includes determining that, of the plurality of psychological statuses, another one psychological status in a rank higher than a rank of the current psychological status to be stored in the storage unit (50) is a new current-psychological status if the at least one index after the update has satisfied one requirement of the plurality of requirements, the one requirement corresponding to the current psychological status.

[Appendix A16] The non-transitory tangible recording medium according to Appendix A15,

in which the determining of the current psychological status includes determining that the other one psychological status in the rank higher than the rank of the current psychological status to be stored in the storage unit (50) is the new current-psychological status if the at least one index after the update
has satisfied the one requirement that corresponds to the current psychological status, and
has satisfied a series of requirements of the plurality of requirements, the series of requirements corresponding to a series of psychological statuses of the plurality of psychological statuses, the series of psychological statuses being in ranks lower than the rank of the current psychological status.
   [Appendix B1] An information processing device, including:

an at least one processor; and

a storage unit configured to store an at least one program that can be executed by the at least one processor,

in which, when the at least one processor executes the at least one program, the at least one processor implements an information processing method including:
acquiring target information about a target;
calculating an at least one index of one of actions and reactions by the target on the basis of the target information after the acquisition;
determining a current psychological status of the target on the basis of the at least one index after the calculation; and
storing the current psychological status after the determination into the storage unit,

in which the current psychological status is one of a plurality of psychological statuses that shift in a stepwise manner,

in which a plurality of requirements corresponding to the plurality of psychological statuses are defined,

in which the plurality of requirements are each a requirement to be satisfied by the at least one index,

in which the calculating of the at least one index includes updating the at least one index on the basis of the target information after the acquisition, and

in which the determining of the current psychological status includes determining that, of the plurality of psychological statuses, another one psychological status in a rank higher than a rank of the current psychological status to be stored in the storage unit is a new current-psychological status if the at least one index after the update has satisfied one requirement of the plurality of requirements, the one requirement corresponding to the other one psychological status in the higher rank.

[Appendix B2] The information processing device according to Appendix B1,

in which the determining of the current psychological status includes determining that the other one psychological status in the rank higher than the rank of the current psychological status to be stored in the storage unit is the new current-psychological status if the at least one index after the update
has satisfied the one requirement that corresponds to the other one psychological status in the higher rank, and
has satisfied a series of requirements of the plurality of requirements, the series of requirements corresponding to a series of psychological statuses of the plurality of psychological statuses, the series of psychological statuses being in ranks lower than the rank of the other one psychological status in the higher rank.
   [Appendix B3] The information processing device according to Appendix B2,

in which the determining of the current psychological status includes determining that, of the plurality of psychological statuses, a still another one psychological status that is in a rank lower than the rank of the current psychological status to be stored in the storage unit and that has satisfied a corresponding one requirement of the plurality of requirements is the new current-psychological status if the at least one index after the update has been prevented from satisfying another one requirement of the plurality of requirements, the other one requirement corresponding to the current psychological status.

[Appendix B4] The information processing device according to Appendix B3,

in which the determining of the current psychological status includes changing, of the plurality of requirements, an at least one requirement that corresponds to an at least one psychological status of the plurality of psychological statuses in accordance with a term in which the at least one psychological status is determined as the current psychological status.

[Appendix B5] An information processing device, including:

an at least one processor; and

a storage unit configured to store an at least one program that can be executed by the at least one processor,

in which, when the at least one processor executes the at least one program, the at least one processor implements an information processing method including:
acquiring target information about a target;
calculating an at least one index of one of actions and reactions by the target on the basis of the target information after the acquisition;
determining a current psychological status of the target on the basis of the at least one index after the calculation; and
storing the current psychological status after the determination into the storage unit,

in which the current psychological status is one of a plurality of psychological statuses that shift in a stepwise manner,

in which a plurality of requirements corresponding to the plurality of psychological statuses are defined,

in which the plurality of requirements are each a requirement to be satisfied by the at least one index,

in which the calculating of the at least one index includes updating the at least one index on the basis of the target information after the acquisition, and

in which the determining of the current psychological status includes determining that, of the plurality of psychological statuses, another one psychological status in a rank higher than a rank of the current psychological status to be stored in the storage unit is a new current-psychological status if the at least one index after the update has satisfied one requirement of the plurality of requirements, the one requirement corresponding to the current psychological status.

[Appendix B6] The information processing device according to Appendix B5,

in which the determining of the current psychological status includes determining that the other one psychological status in the rank higher than the rank of the current psychological status to be stored in the storage unit is the new current-psychological status if the at least one index after the update
has satisfied the one requirement that corresponds to the current psychological status, and
has satisfied a series of requirements of the plurality of requirements, the series of requirements corresponding to a series of psychological statuses of the plurality of psychological statuses, the series of psychological statuses being in ranks lower than the rank of the current psychological status.
   [Appendix B7] The information processing device according to Appendix B6,

in which the determining of the current psychological status includes determining that, of the plurality of psychological statuses, a still another one psychological status in a rank lower than the rank of the current psychological status to be stored in the storage unit is the new current-psychological status if the at least one index after the update has been prevented from satisfying another one requirement of the plurality of requirements, the other one requirement corresponding to the still another one psychological status in the lower rank.

[Appendix B8] The information processing device according to Appendix B7,

in which the determining of the current psychological status includes changing, of the plurality of requirements, an at least one requirement that corresponds to an at least one psychological status of the plurality of psychological statuses in accordance with a term in which another at least one psychological status is determined as the current psychological status, the at least one psychological status being in a rank lower than a rank of the other at least one psychological status.

[Appendix B9] The information processing device according to Appendix B1 or B5,

in which a plurality of evaluation values corresponding to the plurality of psychological statuses are set,

in which the plurality of evaluation values are each a value of a function that uses the at least one index as a variable, and

in which the determining of the current psychological status includes determining whether or not the at least one index has satisfied an at least one requirement of the plurality of requirements, the at least one requirement corresponding to an at least one psychological status of the plurality of psychological statuses
by calculating an at least one evaluation value of the plurality of evaluation values on the basis of the at least one index, the at least one evaluation value corresponding to the at least one psychological status, and
by determining whether or not the at least one evaluation value after the calculation has satisfied the at least one requirement.
   [Appendix B10] The information processing device according to Appendix B9,

in which the determining of the current psychological status includes
determining whether or not the at least one evaluation value calculated for the at least one psychological status has satisfied the at least one requirement on the basis of a result of comparison between the at least one evaluation value and a threshold that is set for the at least one requirement,
calculating proportions of at least two evaluation values of the plurality of evaluation values to thresholds respectively for at least two psychological statuses of the plurality of psychological statuses, the thresholds being set respectively for at least two requirements of the plurality of requirements, the at least two psychological statuses being in ranks higher than the rank of the current psychological status to be stored in the storage unit and in the same rank as each other,
comparing the proportions calculated respectively for the at least two psychological statuses to each other, and
determining, on the basis of a result of the comparison, that one of the at least two psychological statuses is the new current-psychological status, the calculating of the proportions, the comparing of the proportions, and the determining of the one of the at least two psychological statuses being performed if the at least two psychological statuses can each be determined as the new current-psychological status.

The present application claims the benefit of the priority from Japanese Patent Application No. 2019-40979 filed on Mar. 6, 2019, and the entire contents of Japanese Patent Application No. 2019-40979 are incorporated herein by reference.

1. An information processing device, comprising:
at least one processor; and
a storage unit configured to store an at least one program that can be executed by the at least one processor,
wherein, when the at least one processor executes the at least one program, the at least one processor implements an information processing method including:
acquiring target information about a target;
calculating an at least one index of one of actions and reactions by the target on a basis of the target information after the acquisition;
determining a current psychological status of the target on a basis of the at least one index after the calculation; and
storing the current psychological status after the determination into the storage unit,
wherein the current psychological status is one of a plurality of psychological statuses that shift in a stepwise manner,
wherein a plurality of requirements corresponding to the plurality of psychological statuses are defined,
wherein the plurality of requirements are each a requirement to be satisfied by the at least one index,
wherein the calculating of the at least one index includes updating the at least one index on the basis of the target information after the acquisition, and
wherein the determining of the current psychological status includes determining that, of the plurality of psychological statuses, another one psychological status in a rank higher than a rank of the current psychological status to be stored in the storage unit is a new current-psychological status if the at least one index after the update has satisfied one requirement of the plurality of requirements, the one requirement corresponding to the other one psychological status in the higher rank.

2. The information processing device according to claim 1,
wherein the determining of the current psychological status includes determining that the other one psychological status in the rank higher than the rank of the current psychological status to be stored in the storage unit is the new current-psychological status if the at least one index after the update
has satisfied the one requirement that corresponds to the other one psychological status in the higher rank, and
has satisfied a series of requirements of the plurality of requirements, the series of requirements corresponding to a series of psychological statuses of the plurality of psychological statuses, the series of psychological statuses being in ranks lower than the rank of the other one psychological status in the higher rank.

3. The information processing device according to claim 2,
wherein the determining of the current psychological status includes determining that, of the plurality of psychological statuses, a still another one psychological status that is in a rank lower than the rank of the current psychological status to be stored in the storage unit and that has satisfied a corresponding one requirement of the plurality of requirements is the new current-psychological status if the at least one index after the update has been prevented from satisfying another one requirement of the plurality of requirements, the other one requirement corresponding to the current psychological status.

4. The information processing device according to claim 3,
wherein the determining of the current psychological status includes changing, of the plurality of requirements, an at least one requirement that corresponds to an at least one psychological status of the plurality of psychological statuses in accordance with a term in which the at least one psychological status is determined as the current psychological status.

5. An information processing device, comprising:
at least one processor; and
a storage unit configured to store an at least one program that can be executed by the at least one processor,
wherein, when the at least one processor executes the at least one program, the at least one processor implements an information processing method including:
acquiring target information about a target;
calculating an at least one index of one of actions and reactions by the target on a basis of the target information after the acquisition;
determining a current psychological status of the target on a basis of the at least one index after the calculation; and
storing the current psychological status after the determination into the storage unit,
wherein the current psychological status is one of a plurality of psychological statuses that shift in a stepwise manner,
wherein a plurality of requirements corresponding to the plurality of psychological statuses are defined,
wherein the plurality of requirements are each a requirement to be satisfied by the at least one index,
wherein the calculating of the at least one index includes updating the at least one index on the basis of the target information after the acquisition, and
wherein the determining of the current psychological status includes determining that, of the plurality of psychological statuses, another one psychological status in a rank higher than a rank of the current psychological status to be stored in the storage unit is a new current-psychological status if the at least one index after the update has satisfied one requirement of the plurality of requirements, the one requirement corresponding to the current psychological status.

6. The information processing device according to claim 5,
wherein the determining of the current psychological status includes determining that the other one psychological status in the rank higher than the rank of the current psychological status to be stored in the storage unit is the new current-psychological status if the at least one index after the update
has satisfied the one requirement that corresponds to the current psychological status, and
has satisfied a series of requirements of the plurality of requirements, the series of requirements corresponding to a series of psychological statuses of the plurality of psychological statuses, the series of psychological statuses being in ranks lower than the rank of the current psychological status.

7. The information processing device according to claim 6,
wherein the determining of the current psychological status includes determining that, of the plurality of psychological statuses, a still another one psychological status in a rank lower than the rank of the current psychological status to be stored in the storage unit is the new current-psychological status if the at least one index after the update has been prevented from satisfying another one requirement of the plurality of requirements, the other one requirement corresponding to the still another one psychological status in the lower rank.

8. The information processing device according to claim 7,
wherein the determining of the current psychological status includes changing, of the plurality of requirements, an at least one requirement that corresponds to an at least one psychological status of the plurality of psychological statuses in accordance with a term in which another at least one psychological status is determined as the current psychological status, the at least one psychological status being in a rank lower than a rank of the other at least one psychological status.

9. The information processing device according to claim 5,
wherein a plurality of evaluation values corresponding to the plurality of psychological statuses are set,
wherein the plurality of evaluation values are each a value of a function that uses the at least one index as a variable, and
wherein the determining of the current psychological status includes determining whether or not the at least one index has satisfied an at least one requirement of the plurality of requirements, the at least one requirement corresponding to an at least one psychological status of the plurality of psychological statuses
by calculating an at least one evaluation value of the plurality of evaluation values on the basis of the at least one index, the at least one evaluation value corresponding to the at least one psychological status, and
by determining whether or not the at least one evaluation value after the calculation has satisfied the at least one requirement.

10. The information processing device according to claim 9,
wherein the determining of the current psychological status includes
determining whether or not the at least one evaluation value calculated for the at least one psychological status has satisfied the at least one requirement on a basis of a result of comparison between the at least one evaluation value and a threshold that is set for the at least one requirement,
calculating proportions of at least two evaluation values of the plurality of evaluation values to thresholds respectively for at least two psychological statuses of the plurality of psychological statuses, the thresholds being set respectively for at least two requirements of the plurality of requirements, the at least two psychological statuses being in ranks higher than the rank of the current psychological status to be stored in the storage unit and in the same rank as each other,
comparing the proportions calculated respectively for the at least two psychological statuses to each other, and
determining, on the basis of a result of the comparison, that one of the at least two psychological statuses is the new current-psychological status, the calculating of the proportions, the comparing of the proportions, and the determining of the one of the at least two psychological statuses being performed if the at least two psychological statuses can each be determined as the new current-psychological status.

11. An information processing method to be executed by an at least one computer, the information processing method comprising:
acquiring target information about a target;
calculating an at least one index of one of actions and reactions by the target on a basis of the target information after the acquisition;
determining a current psychological status of the target on a basis of the at least one index after the calculation; and
storing the current psychological status after the determination into a storage unit,
wherein the current psychological status is one of a plurality of psychological statuses that shift in a stepwise manner,
wherein a plurality of requirements corresponding to the plurality of psychological statuses are defined,
wherein the plurality of requirements are each a requirement to be satisfied by the at least one index,
wherein the calculating of the at least one index includes updating the at least one index on the basis of the target information after the acquisition, and
wherein the determining of the current psychological status includes determining that, of the plurality of psychological statuses, another one psychological status in a rank higher than a rank of the current psychological status to be stored in the storage unit is a new current-psychological status if the at least one index after the update has satisfied one requirement of the plurality of requirements, the one requirement corresponding to the other one psychological status in the higher rank.

12. An information processing method to be executed by at least one computer, the information processing method comprising:
acquiring target information about a target;
calculating an at least one index of one of actions and reactions by the target on a basis of the target information after the acquisition;
determining a current psychological status of the target on a basis of the at least one index after the calculation; and
storing the current psychological status after the determination into a storage unit,
wherein the current psychological status is one of a plurality of psychological statuses that shift in a stepwise manner,
wherein a plurality of requirements corresponding to the plurality of psychological statuses are defined,
wherein the plurality of requirements are each a requirement to be satisfied by the at least one index,
wherein the calculating of the at least one index includes updating the at least one index on the basis of the target information after the acquisition, and
wherein the determining of the current psychological status includes determining that, of the plurality of psychological statuses, another one psychological status in a rank higher than a rank of the current psychological status to be stored in the storage unit is a new current-psychological status if the at least one index after the update has satisfied one requirement of the plurality of requirements, the one requirement corresponding to the current psychological status.

13. The information processing method according to claim 12,
wherein the determining of the current psychological status includes determining that the other one psychological status in the rank higher than the rank of the current psychological status to be stored in the storage unit is the new current-psychological status if the at least one index after the update
has satisfied the one requirement that corresponds to the current psychological status, and
has satisfied a series of requirements of the plurality of requirements, the series of requirements corresponding to a series of psychological statuses of the plurality of psychological statuses, the series of psychological statuses being in ranks lower than the rank of the current psychological status.

14. A non-transitory tangible recording medium that stores an at least one program for causing an at least one computer to implement an information processing method, the information processing method comprising:
acquiring target information about a target;
calculating an at least one index of one of actions and reactions by the target on a basis of the target information after the acquisition;
determining a current psychological status of the target on a basis of the at least one index after the calculation; and
storing the current psychological status after the determination into a storage unit,
wherein the current psychological status is one of a plurality of psychological statuses that shift in a stepwise manner,
wherein a plurality of requirements corresponding to the plurality of psychological statuses are defined,
wherein the plurality of requirements are each a requirement to be satisfied by the at least one index,
wherein the calculating of the at least one index includes updating the at least one index on the basis of the target information after the acquisition, and
wherein the determining of the current psychological status includes determining that, of the plurality of psychological statuses, another one psychological status in a rank higher than a rank of the current psychological status to be stored in the storage unit is a new current-psychological status if the at least one index after the update has satisfied one requirement of the plurality of requirements, the one requirement corresponding to the other one psychological status in the higher rank.

15. A non-transitory tangible recording medium that stores an at least one program for causing an at least one computer to implement an information processing method, the information processing method comprising:
acquiring target information about a target;
calculating an at least one index of one of actions and reactions by the target on a basis of the target information after the acquisition;
determining a current psychological status of the target on a basis of the at least one index after the calculation; and
storing the current psychological status after the determination into a storage unit,
wherein the current psychological status is one of a plurality of psychological statuses that shift in a stepwise manner,
wherein a plurality of requirements corresponding to the plurality of psychological statuses are defined,
wherein the plurality of requirements are each a requirement to be satisfied by the at least one index,
wherein the calculating of the at least one index includes updating the at least one index on the basis of the target information after the acquisition, and
wherein the determining of the current psychological status includes determining that, of the plurality of psychological statuses, another one psychological status in a rank higher than a rank of the current psychological status to be stored in the storage unit is a new current-psychological status if the at least one index after the update has satisfied one requirement of the plurality of requirements, the one requirement corresponding to the current psychological status.

16. The non-transitory tangible recording medium according to claim 15,
wherein the determining of the current psychological status includes determining that the other one psychological status in the rank higher than the rank of the current psychological status to be stored in the storage unit is the new current-psychological status if the at least one index after the update
has satisfied the one requirement that corresponds to the current psychological status, and
has satisfied a series of requirements of the plurality of requirements, the series of requirements corresponding to a series of psychological statuses of the plurality of psychological statuses, the series of psychological statuses being in ranks lower than the rank of the current psychological status.
